(19) United States
(12) Patent Application Publication
(10) Pub. No.: US 2011/0147969 A1
(43) Pub. Date: Jun. 23, 2011

(54) APPARATUS AND METHOD OF FABRICATING FLAT PLATE DISPLAY

(76) Inventor: Tae-Joon SONG, Paju-si (KR)

(21) Appl. No.: 12/912,485

(22) Filed: Oct. 26, 2010

(30) Foreign Application Priority Data
Dec. 23, 2009 (KR) 10-2009-0129798

(51) Int. Cl. B29C 59/02; B29C 59/00

(52) U.S. Cl. 264/40.1; 425/385; 425/143; 264/293

(57) ABSTRACT

A fabricating apparatus and a method of a flat plate display are disclosed. A fabricating apparatus of a flat plate display includes a stage on which a substrate is seated, an imprinting mold bonded with the substrate to form a thin film pattern on the substrate, the imprinting mold comprises projections and grooves, and a temperature adjusting part configured to compensate a total pitch of the substrate as much as total pitch difference with a total pitch of the imprinting mold before the imprinting mold is bonded with the substrate.

### CROSS REFERENCE TO RELATED APPLICATION

This application claims the benefit of the Patent Korean Application No. 10-2009-0129798, filed on Dec. 23, 2009, which is hereby incorporated by reference as if fully set forth herein.

### BACKGROUND OF THE DISCLOSURE

1. Field of the Disclosure

The present invention relates to a fabricating apparatus and method of a flat plate display which can compensate a total pitch of a substrate to correspond with a total pitch of an imprinting mold.

2. Discussion of the Related Art

Various kinds of flat plate displays capable of reducing a weight and volume which are disadvantages of a cathode ray tube (CRT) have been emerging recently. Such a flat plate display includes a liquid crystal display (LCD), a field emission display, a plasma display panel and an electro-luminescence (EL) display.

This flat plate display is configured of a plurality of thin films formed by a mask process including depositing (coating), exposing, developing and etching. However, the mask process has complicated fabricating assembly process and it has a disadvantage of high production cost. As a result, research and study have been under progress to form thin films via a patterning process using an imprinting mold in recent.

According to this patterning process, when a liquid polymeric precursor contacts with an imprinting mold which has a groove and a projection after liquid resin is painted on a substrate, the groove and the projection of the imprinting mold are reverse-transferred to the liquid polymeric precursor and the reverse-transferred liquid polymeric precursor is hardened in a hardening process to form a desired thin film pattern on the substrate.

However, in case total pitch difference between the imprinting mold and the substrate is generated, overlay accuracy of the pattern formed via the imprinting mold will deteriorate enough to cause a pattern error disadvantageously. To solve this problem, the imprinting mold is re-fabricated to compensate its total pitch. That is, after the total pitch of a master mold for fabricating the imprinting mold, the imprinting mold has to be re-fabricated by using the compensated master mold disadvantageously.

### SUMMARY OF THE DISCLOSURE

Accordingly, the present invention is directed to a fabricating apparatus and method of a flat plate display.

An advantage of the present invention is to provide a fabricating apparatus of a flat plate display which is able to compensate a total pitch of a substrate to correspond with a total pitch of an imprinting mold.

Additional advantages, objects, and features of the disclosure will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a fabricating apparatus of a flat plate display includes a stage on which a substrate is seated; an imprinting mold bonded with the substrate to form a thin film pattern on the substrate, the imprinting mold comprises projections and grooves; and a temperature adjusting part configured to compensate a total pitch of the substrate as much as total pitch difference between the imprinting mold and the substrate before the imprinting mold is bonded with the substrate.

The fabricating apparatus may further include a measuring part configured to measure the total pitch of the imprinting mold and the total pitch of the substrate; and a controller configured to control the temperature adjusting part as much as the total pitch difference between the imprinting mold and the substrate.

The temperature adjusting part may increase the temperature of the substrate seated on the stage to increase the total pitch of the substrate when the total pitch of the imprinting mold is larger than the total pitch of the substrate, and the temperature adjusting part may decrease the total pitch of the substrate the temperature of the substrate seated on the stage to decrease the total pitch of the substrate when the total pitch of the imprinting mold is smaller than the total pitch of the substrate.

The temperature adjusting part may be formed of a water tube configured to supply hot or cold water or a hot wire.

The substrate may be transferred to a chamber for imprinting in which the imprinting mold is located after a total pitch of the substrate is compensated in an auxiliary chamber different from the chamber for imprinting.

In another aspect of the present invention, a fabricating method of a flat plate display includes steps of: seating a substrate having liquid polymeric precursor formed thereon on a stage; aligning an imprinting mold on the substrate, the imprinting mold comprising grooves and projections; compensating a total pitch of the substrate as much as a total pitch difference between the imprinting mold and the substrate by using a temperature adjusting part; bonding the imprinting mold and the substrate with each other; and separating the imprinting mold and the substrate from each other.

The fabricating method may further include steps of: measuring the total pitches of the imprinting mold and the substrate; and controlling the temperature adjusting as much as the total pitch difference between the imprinting mold and the substrate.

The step of compensating the total pitch of the substrate may increase the temperature of the substrate seated on the stage to increase the total pitch of the substrate when the total pitch of the imprinting mold is larger than the total pitch of the substrate, and the step may decrease the temperature of the substrate seated on the stage to decrease the total pitch of the substrate when the total pitch of the imprinting mold is smaller than the total pitch of the substrate.

The temperature adjusting part may be formed of a water tube configured to supply hot or cold water or a hot wire.

The substrate may be transferred to a chamber for imprinting in which the imprinting mold is located, after a total pitch of the substrate is compensated in an auxiliary chamber different from the chamber for imprinting.

The present invention may have following advantages.

According to the fabricating apparatus and method of the flat plate display, the total pitch of the substrate is compensated by the temperature adjusting part located in the stage to correspond with the total pitch of the imprinting mold. As a result, the overlay accuracy of the substrate and the imprinting mold may be enhanced without re-fabrication of the imprinting mold and a pattern error may be prevented accordingly.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure.

In the drawings:

FIG. 1 is a sectional view illustrating a fabricating apparatus of a flat plate display according to an exemplary embodiment of the present invention;

FIGS. 2A to 2D are sectional views illustrating a fabricating method of a flat plate display using the fabricating apparatus shown in FIG. 1;

FIG. 3 is a sectional view illustrating a fabricating apparatus of a flat plate display according to another embodiment of the present invention;

FIG. 4A to 4C are sectional views illustrating a fabricating method of a flat plate display using the fabricating apparatus shown in FIG. 3; and

FIG. 5 is a perspective view illustrating a liquid crystal display panel having a thin film pattern formed by the fabricating method shown in FIGS. 2A to 2D or FIGS. 4A to 4C.

### DESCRIPTION OF SPECIFIC EMBODIMENTS

Reference will now be made in detail to the specific embodiments of the present invention, examples of which are illustrated in the accompanying drawings. Wherever possible, the same reference numbers will be used throughout the drawings to refer to the same or like parts.

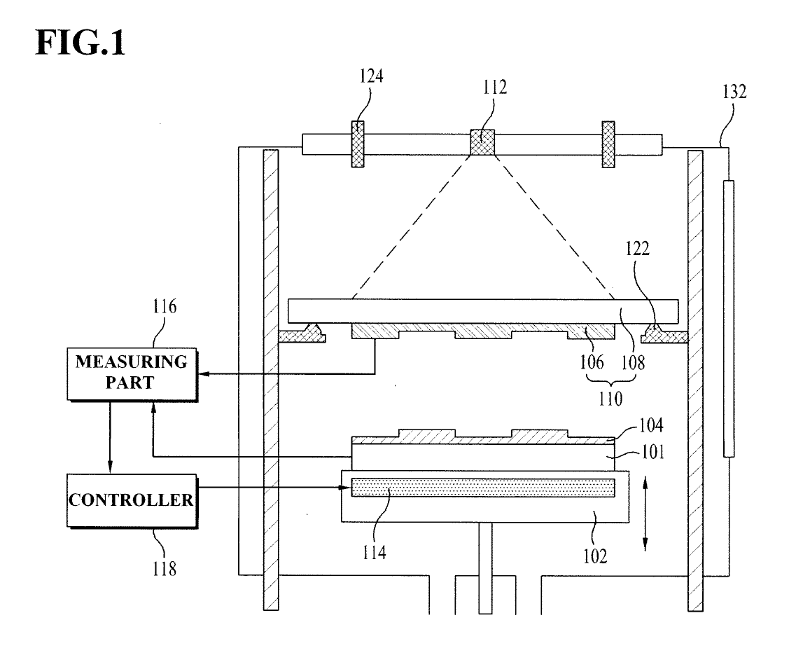

FIG. 1 is a sectional view illustrating a fabricating apparatus of a flat plate display according to an exemplary embodiment of the present invention.

The fabricating apparatus for imprinting shown in FIG. 1 includes a substrate 101, an imprinting mold 110, a light source part 112, a vision part 124, a supporter 122, a measuring part 116, a temperature adjusting part 114 and a controller 118.

The substrate 101 is vacuum-absorbed to a stage 102 and it is seated on the stage 102. On such the substrate 101 may be formed a thin film pattern 104 configured of liquid polymeric precursor patterned by pressing-contact with the imprinting mold 110. The thin film pattern 104 has a predetermined shape reverse-transferred from grooves and projections of the imprinting mold 110.

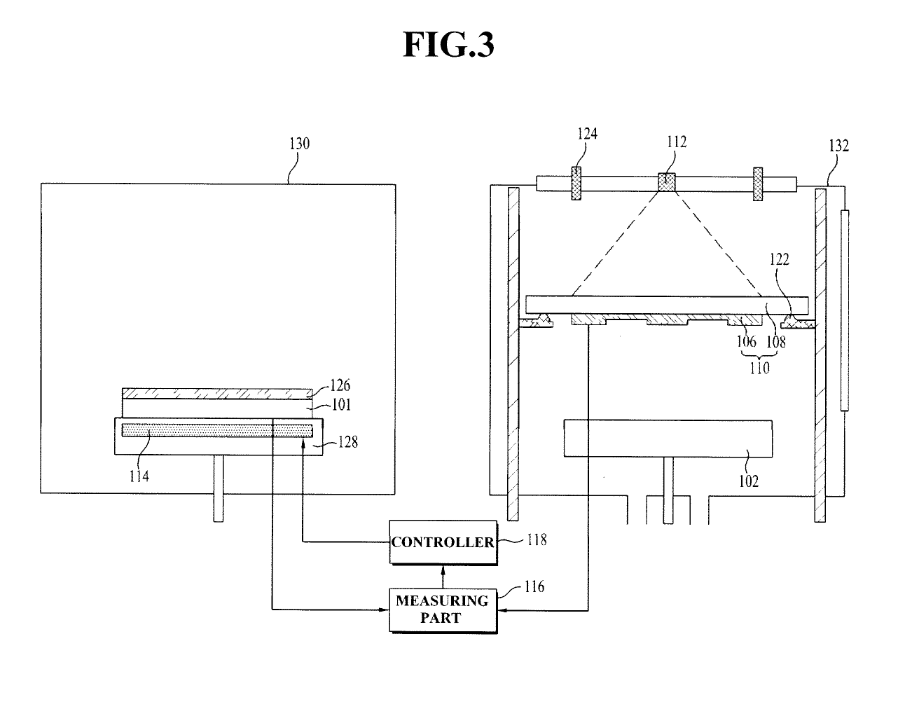

The imprinting mold 110 includes a back plane 108 and a mold part 106 formed on the back plane 108. The size of the back plane 108 may be formed larger than the size of the substrate 101 as shown in FIG. 3. The size of the mold part 106 may be formed similar to the size of the substrate and it includes grooves and projections to form the thin film pattern 104.

The light source part 112 emits lights such as ultraviolet rays or infrared rays to the imprinting mold 110 to harden the thin film pattern 104 formed on the substrate 101.

The vision part 124 identifies a location difference between the imprinting mold 110 and the substrate 101 and it compensate the difference.

The supporter 122 is formed to allow an edge of a back surface of the back plane 108 of the imprinting mold 110 seated thereon. That is, the supporter 122 contacts with the edge of the back surface of the imprinting mold 110. As a result, the supporter 122 may not affect the moving passage of the ultraviolet rays or infrared rays when the liquid polymeric precursor is hardened by using the light source part 112.

The measuring part 116 measures total pitches of the imprinting mold 110 and the substrate 101.

The controller 118 controls the temperature adjusting part 114 to compensate the total pitch of the substrate 101 as much as the total pitch difference between the imprinting mold 110 and the substrate 101 which is measured by the measuring part 116.

The temperature adjusting part 114 adjusts the temperature of the substrate 101 seated on the stage 102 to compensate the total pitch of the substrate as much as the total pitch difference between the imprinting mold 110 and the substrate 101. this temperature adjusting part 114 may be formed of a water tube or hot wire configured to supply hot water or cold water received in the stage 102.

That is, if the total pitch of the imprinting mold 110 is larger than the total pitch of the substrate 101, the temperature of the stage 102 having the substrate 101 seated thereon is increased, for example, up to 28° C. to increase the total pitch of the substrate 101. if the total pitch of the imprinting mold 110 is smaller than that of the substrate 101, the temperature of the stage 102 having the substrate 101 seated thereon is decreased, for example, down to 20° C. to decrease the total pitch of the substrate 101.

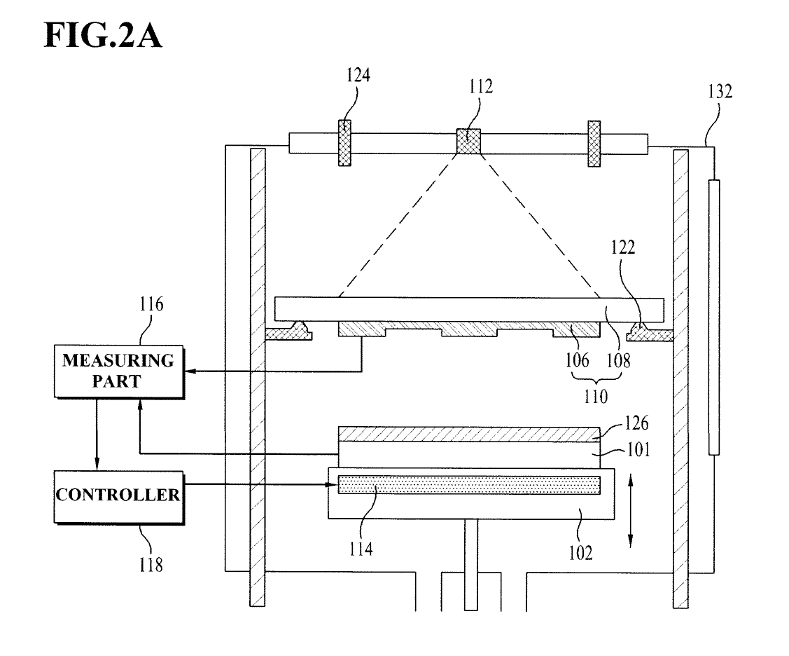

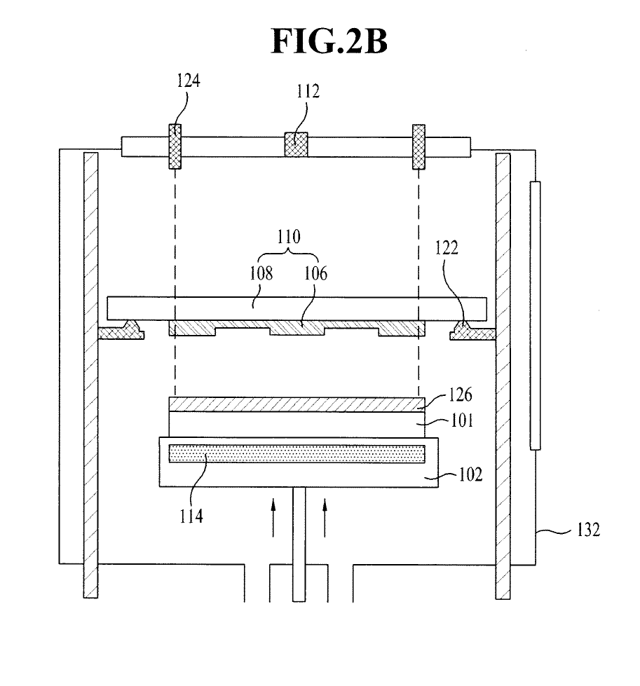

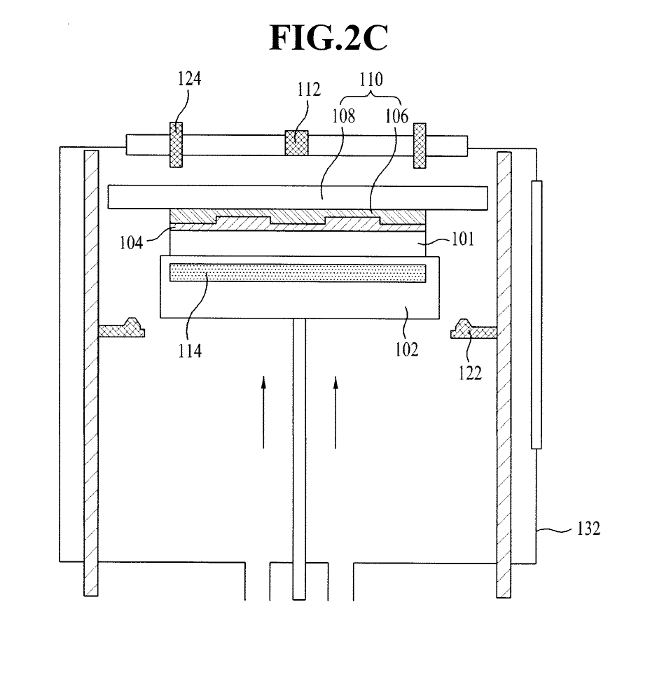

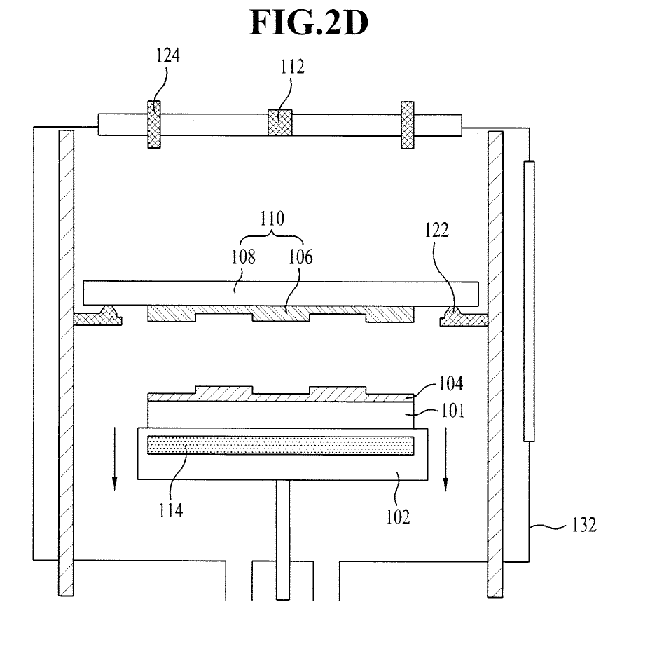

FIGS. 2A to 2D are sectional views illustrating a fabricating method of a flat plate display which uses the fabricating apparatus shown in FIG. 1.

First of all, the liquid polymeric precursor 126 is coated, for example, spin-coated, spinless-coated and the like on the substrate 101. The substrate 101 having the liquid polymeric precursor 126 is seated on the stage 102 as shown in FIG. 2A. the total pitch of the substrate 101 seated on the stage 102 and the total pitch of the imprinting mold 110 located beyond the substrate 101 are measured. If there is difference between the total pitches of the substrate 101 and the imprinting mold 110 based on the result of the measurement, the controller 118 controls the temperature adjusting part 114 for the total pitches of the substrate 101 and the imprinting mold 110 to correspond with each other. That is, if the total pitch of the imprinting mold 110 is larger than the total pitch of the substrate 101, the temperature of the substrate 101 seated on the stage 102 is increased by using the temperature adjusting part 114 to increase the total pitch of the substrate 101. If the total pitch of the imprinting mold is smaller than the total pitch of the substrate 101, the temperature of the substrate 101 seated on the stage 102 is decreased by using the temperature adjusting part 114 to decrease the total pitch of the substrate 101.

When the total pitch of the imprinting mold 110 is corresponding with the total pitch of the substrate 101 by using the temperature adjusting part 114, the stage 102 having the substrate 101 seated thereon may moves upward by the maximum height enough not to be in contact with the imprinting mold 110, as shown in FIG. 2B. After that, the imprinting mold 110 and the substrate 101 are aligned to for align-keys (not shown) formed in both the imprinting mold 110 and the substrate 101 via the vision part 124 to correspond with each other.

The stage 102 having the substrate aligned to the imprinting mold 110 thereon may move upward higher than the height of the supporter 122 as shown in FIG. 2C. When the stage 102 moves upward higher than the supporter 122, the imprinting mold 110 is bonded with the substrate 101. After that, solvent in the liquid polymeric precursor is absorbed to a surface of the imprinting mold 110 to move the liquid polymeric precursor into the grooves of the imprinting mold 110 and the liquid polymeric precursor is hardened by the light source part 112 to form the thin pattern 104 on the substrate 101. The thin film pattern 104 has a shape reverse-transferred from the grooves of the imprinting mold 110.

Hence, as shown in FIG. 2D, the stage 102 on which the substrate 101 having the thin film pattern 104 formed therein is seated may move downward and the imprinting mold 110 is horizontally fixed to the supporter 122 and the substrate 101 having the thin film pattern 104 formed thereon is separated from the imprinting mold 110.

FIG. 3 is a diagram illustrating a fabricating apparatus for imprinting according to another embodiment of the present invention.

The fabricating apparatus shown in FIG. 3 includes identical components to the fabricating apparatus shown in FIG. 1, except a buffer chamber 130 additionally provided therein and detailed descriptions of the identical components will be omitted accordingly.

The buffer chamber 130 is formed adjacent to a chamber for imprinting 132. In such the buffer chamber 130 may be formed a buffer stage 128 in which the substrate 101 having the liquid polymeric precursor 126 formed thereon is seated and the temperature adjusting part 114 mounted in the buffer stage 128.

The temperature of the substrate 101 seated on the buffer stage 128 is adjusted by the temperature adjusting part 114 to compensate the total pitch of the substrate as much as the total pitch difference with the imprinting mold 110. that is, if the total pitch of the imprinting mold 110 is larger than the total pitch of the substrate 101, the temperature of the stage 102 having the substrate 101 seated thereon is increased, for example, up to 28° C. to increase the total pitch of the substrate 101. if the total pitch of the imprinting mold 110 is smaller than the total pitch of the substrate 101, the temperature of the stage 102 having the substrate 101 seated thereon is decreased, for example, down to 20° C. to decrease the total pitch of the substrate 101.

The substrate 101 having the total pitch compensated in the buffer chamber 130 is transferred to the chamber for imprinting 132 for an imprinting process.

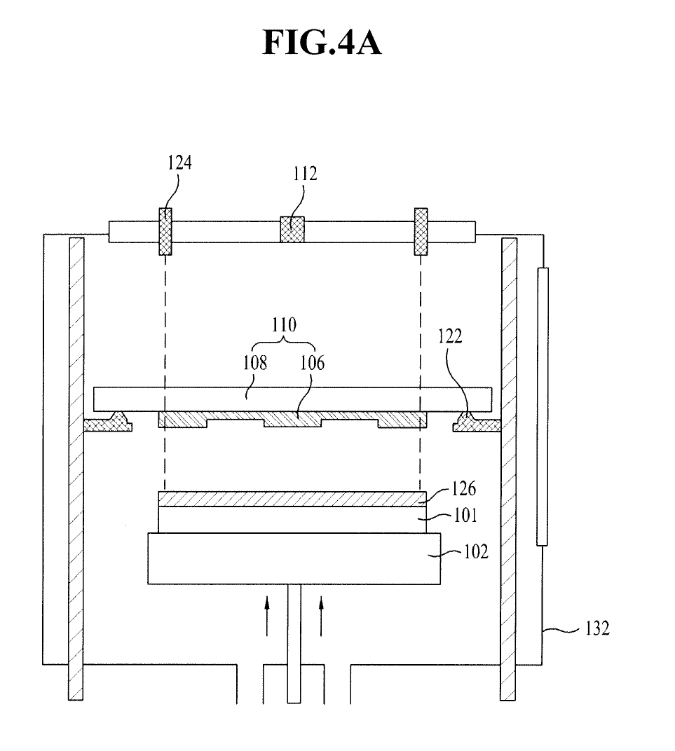

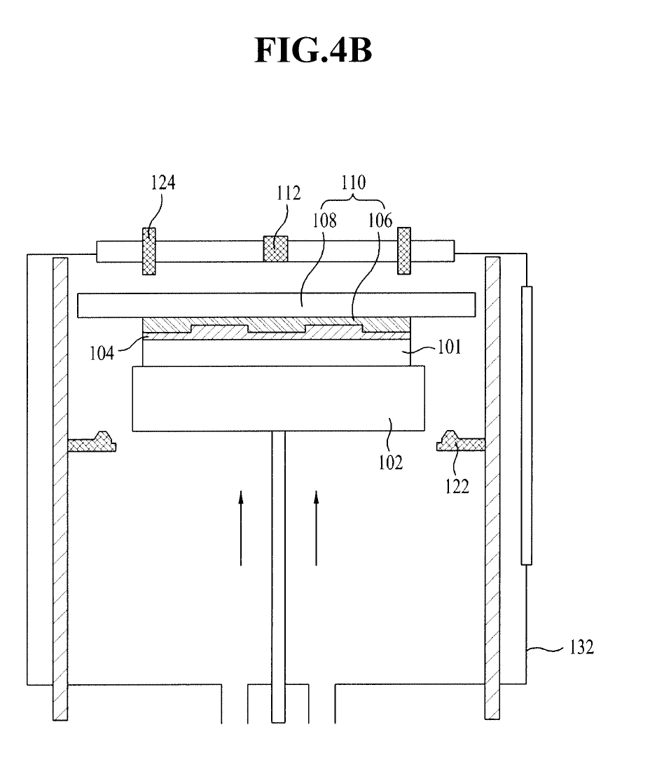

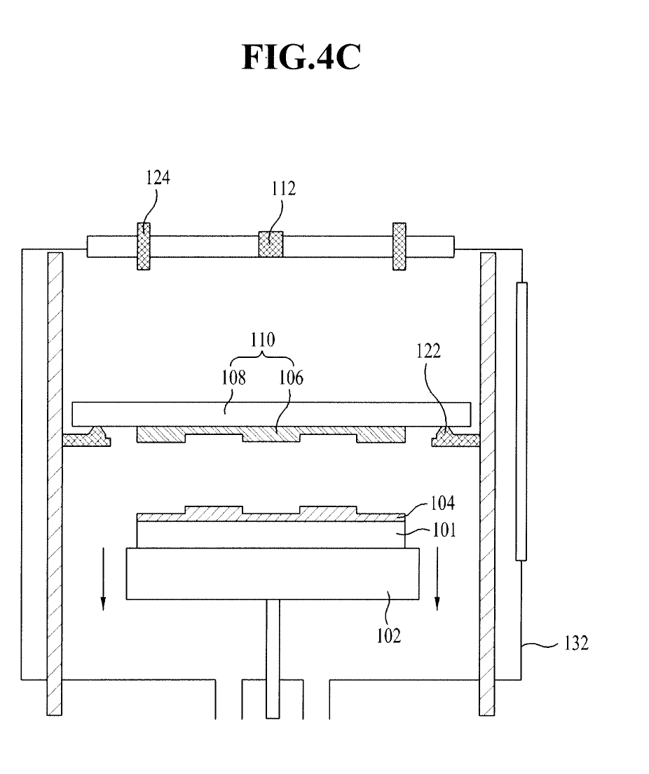

FIGS. 4A to 4C are sectional views illustrating a fabricating method of a thin film pattern using the fabricating apparatus of the flat plate display shown in FIG. 3.

First of all, the liquid polymeric precursor 126 is coated, for example, spin-coated, spinless-coated and the like on the substrate 101. The substrate 101 having the liquid polymeric precursor 126 formed thereon is seated on the buffer stage 128 of the buffer chamber 130 as shown in FIG. 3. the total pitch of the substrate 101 seated on the buffer stage 128 and the total pitch of the imprinting mold 110 located in the chamber for imprinting 132 are measured by the measuring part 116. if there is total pitch difference between the substrate 101 and the imprinting mold 110 based on the result of the measurement, the controller 118 controls the temperature adjusting part 114 for the total pitches of the substrate 101 and the imprinting mold 110 to correspond with each other. That is, if the total pitch of the imprinting mold 110 is larger than the total pitch of the substrate 101, the temperature of the substrate 101 seated on the buffer stage 128 is increased by using the temperature adjusting part 114 to increase the total pitch of the substrate 101. If the total pitch of the imprinting mold is smaller than the total pitch of the substrate 101, the temperature of the substrate 101 seated on the buffer stage 128 is decreased by using the temperature adjusting part 114 to decrease the total pitch of the substrate 101.

When the total pitch of the imprinting mold 110 is corresponding with the total pitch of the substrate 101 by using the temperature adjusting part 114, the substrate 101 seated on the buffer stage 128 may be transferred to the chamber 132 for imprinting 132 as shown in FIG. 4A. after the transferred substrate 101 is seated on the stage for imprinting 102, the stage for imprinting 102 having the substrate 101 seated thereon may moves upward by the maximum height enough not to be in contact with the imprinting mold 110, as shown in FIG. 4A. After that, the imprinting mold 110 and the substrate 101 are aligned to for align-keys (not shown) formed in both the imprinting mold 110 and the substrate 101 via the vision part 124 to correspond with each other.

The stage for imprinting 102 having the substrate 101 aligned to the imprinting mold 110 thereon may move upward higher than the supporter 122 as shown in FIG. 4B. When the stage for imprinting 102 moves upward higher than the supporter 122, the imprinting mold 110 is bonded with the substrate 101. After that, solvent in the liquid polymeric precursor is absorbed to a surface of the imprinting mold 110 to move the liquid polymeric precursor into the grooves of the imprinting mold 110 and the liquid polymeric precursor is hardened by the light source part 112 to form the thin pattern 104 on the substrate 101. The thin film pattern 104 has a shape reverse-transferred from the grooves of the imprinting mold 110.

Hence, as shown in FIG. 4C, the stage for imprinting 102 on which the substrate 101 having the thin film pattern 104 formed therein is seated may move downward. Hence, the imprinting mold 110 is horizontally fixed to the supporter 122 and the substrate 101 having the thin film pattern 104 formed thereon is separated from the imprinting mold 110.

According to the fabricating apparatus and method of the flat plate display described above, the total pitch of the substrate 101 is compensated by the temperature adjusting part 114 located in the stages 102 and 128 to be corresponding with the total pitch of the imprinting mold 110. that is, when the temperature of the substrate 101 seated on the stage 102 and 128 is adjusted by the temperature adjusting part 114, long axes (L1, L2, L3, L4, L5 and L6) and short axes (S1, S2, S3, S4, S5 and S6) of the plurality of the substrates 101 may be changed to correspond with the total pitch of the imprinting mold 110 as shown in TABLE 1.

TABLE 1
<Change Of Substrate Long Axis (L1~L6) According To
Temperature>

| | L1 [μm] | L2 [μm] | L3 [μm] | L4 [μm] | L5 [μm] | L6 [μm] |
|---|---|---|---|---|---|---|
| 22.1° C. | 0.36 | 0.45 | 0.42 | 0.50 | 0.50 | 0.47 |
| 26.2° C. | 0.71 | 0.51 | 0.55 | 0.53 | 0.55 | 0.58 |

<Change Of Substrate Short Axis (S1~S6) According To
Temperature>

| | S1 [μm] | S2 [μm] | S3 [μm] | S4 [μm] | S5 [μm] | S6 [μm] |
|---|---|---|---|---|---|---|
| 22.1° C. | 0.49 | 0.16 | 0.21 | 0.21 | 0.08 | 0.13 |
| 26.2° C. | 0.87 | 0.78 | 0.61 | 0.68 | 0.88 | 0.60 |

As a result, according to the fabricating apparatus and method of the flat plate display, the overlay accuracy of the substrate and the imprinting mold may be enhanced without re-fabrication of the imprinting mold and the pattern error may be prevented accordingly.

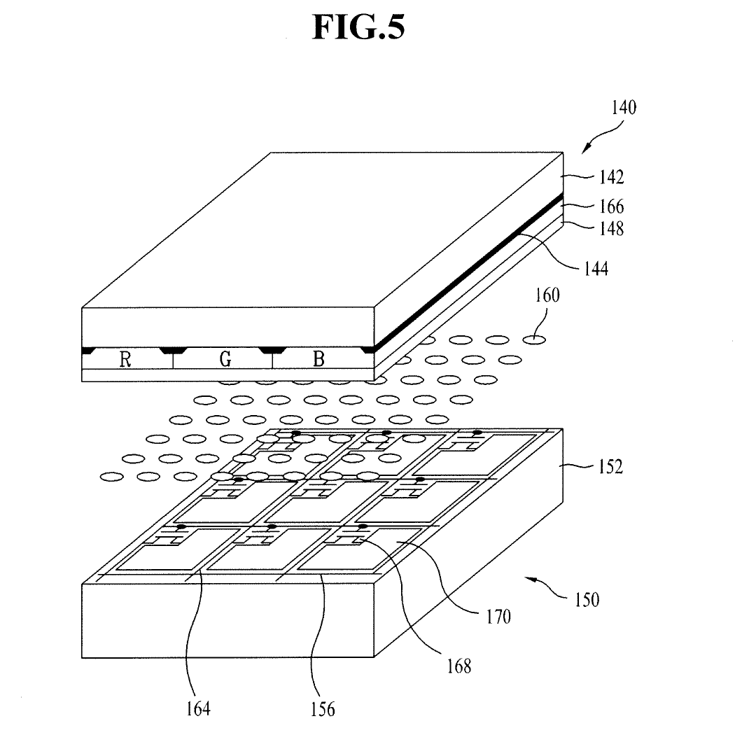

The thin film pattern 104 formed by using the imprinting mold 110 is to a liquid crystal display panel shown in FIG. 5. specifically, the liquid crystal display panel according to the present invention shown in FIG. 5 includes a thin film transistor substrates 150 and a color filter substrate 140 which are bonded in opposite, with a liquid crystal layer 160 formed there between.

The color filter substrate 140 includes a black matrix 144 formed on a top substrate 142 to prevent light escape, a color filter 166 configured to represent colors, a common electrode 148 configured to form a pixel electrode and an electric field, a cover-coat layer configured for planarization, a column spacer formed on the over-coat layer to maintain a cell gap and a top alignment layer (not shown) configured to cover the other components.

The thin film transistor substrate 150 includes gate lines 156 and data lines 164 which are formed on a lower substrate 152 with crossing each other, thin film transistors 168 located adjacent to cross points of the gate and data lines, pixel electrodes 170 formed in pixel regions formed by the cross-over structure, and a lower alignment layer (not shown) configured to cover the other components.

Such the color filter 166, black matrix 154, column spacer, thin film transistors 168, gate lines 156 and data lines 164 and pixel electrode 170 may be formed by the patterning process using the above imprinting mold including the grooves corresponding to patterns thereof.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A fabricating apparatus of a flat plate display comprising:
a stage on which a substrate is seated;
an imprinting mold bonded with the substrate to form a thin film pattern on the substrate, the imprinting mold comprises projections and grooves; and
a temperature adjusting part configured to compensate a total pitch of the substrate as much as a total pitch difference between the imprinting mold and the substrate before the imprinting mold is bonded with the substrate.

2. The fabricating apparatus of claim 1, further comprising:
a measuring part configured to measure the total pitch of the imprinting mold and the total pitch of the substrate; and
a controller configured to control the temperature adjusting part as much as the total pitch difference between the imprinting mold and the substrate.

3. The fabricating apparatus of claim 1, wherein the temperature adjusting part increases the temperature of the substrate seated on the stage to increase the total pitch of the substrate when the total pitch of the imprinting mold is larger than the total pitch of the substrate, and the temperature adjusting part decreases the total pitch of the substrate the temperature of the substrate seated on the stage to decrease the total pitch of the substrate when the total pitch of the imprinting mold is smaller than the total pitch of the substrate.

4. The fabricating apparatus of claim 3, wherein the temperature adjusting part is formed of a water tube configured to supply hot or cold water or a hot wire.

5. The fabricating apparatus of claim 1, wherein the substrate is transferred to a chamber for imprinting in which the imprinting mold is located after a total pitch of the substrate is compensated in an auxiliary chamber different from the chamber for imprinting.

6. A fabricating method of a flat plate display comprising steps of:
seating a substrate having liquid polymeric precursor formed thereon on a stage;
aligning an imprinting mold on the substrate, the imprinting mold comprising grooves and projections;
compensating a total pitch of the substrate as much as a total pitch difference between the imprinting mold and the substrate by using a temperature adjusting part;
bonding the imprinting mold and the substrate with each other; and
separating the imprinting mold and the substrate from each other.

7. The fabricating method of claim 6, further comprising steps of:
measuring the total pitches of the imprinting mold and the substrate; and
controlling the temperature adjusting as much as the total pitch difference between the imprinting mold and the substrate.

8. The fabricating method of claim 6, wherein the step of compensating the total pitch of the substrate increases the temperature of the substrate seated on the stage to increase the total pitch of the substrate when the total pitch of the imprinting mold is larger than the total pitch of the substrate, and the step decreases the temperature of the substrate seated on the stage to decrease the total pitch of the substrate when the total pitch of the imprinting mold is smaller than the total pitch of the substrate.

9. The fabricating method of claim 8, wherein the temperature adjusting part is formed of a water tube configured to supply hot or cold water or a hot wire.

10. The fabricating method of claim 6, wherein the substrate is transferred to a chamber for imprinting in which the imprinting mold is located after a total pitch of the substrate is compensated in an auxiliary chamber different from the chamber for imprinting.
